(19) United States
(12) Patent Application Publication
(10) Pub. No.: US 2020/0062039 A1
(43) Pub. Date: Feb. 27, 2020

(54) VEHICLE TIRES

(71) Applicant: Elan AMIRAV, Geulim (IL)

(72) Inventor: Elan AMIRAV, Geulim (IL)

(21) Appl. No.: 16/610,609

(22) PCT Filed: Mar. 26, 2018
(86) PCT No.: PCT/IL2018/050346

§ 371 Date: Nov. 4, 2019

(30) Foreign Application Priority Data
Jun. 25, 2017 (IL) 253151

(51) Int. Cl. B60C 11/00

(52) U.S. Cl. CPC B60C 11/0083; B60C 2200/14

(57) ABSTRACT

A multi-purpose tire comprising: a tread section comprising a main tread zone and at least one auxiliary tread zone, the tread section is configured to facilitate, at a first inflation pressure, a first tread configuration, wherein the at least one auxiliary tread section makes contact with a road surface and, at a second inflation pressure, a second tread configuration, wherein a contact of the at least one auxiliary tread section with the road is prevented or reduced, the first inflation pressure being lower than the second inflation pressure, wherein the tread section further comprises, in an inner surface thereof, one or more channels extending continuously in a circumferential direction of the tire and configured to regulate an inflation-pressure-dependent transition between the first and second tread configurations.

### FIELD OF THE INVENTION

Embodiments of the disclosure relate to tires and methods of manufacturing and use thereof.

### BACKGROUND

Monitoring tire pressure and applying the right pressure for a given road condition and driving requirement may save substantially in fuel consumption and tire wear. Therefore, it is common in off-road driving, for example, to decrease tire pressure when entering a soft or sandy path and increasing pressure to recommended value when back on paved road. In many cases drivers keep a pump on board for inflating tires after driving on deflated tires. Furthermore, as the awareness of this subject increases, in recent years central systems are available and often installed in heavy vehicles for monitoring and controlling the exact required pressure for a given road condition/driving requirement.

Moreover, the tires are generally being manufactured for one given optimal air pressure. In such cases, under-inflation or over-inflation typically result in low tire-road contact area.

There is still a need in the art for tires that will effectively facilitate driving under various conditions.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

According to some embodiments, there is provided a multipurpose tire.

According to some embodiments, the multipurpose tire disclosed herein advantageously facilitates a desired (predetermined) contact with the road at any inflation pressure.

According to additional or alternative embodiments, the multipurpose tire disclosed herein advantageously facilitates controlling the desired tread surface properties by controlling the tire's inflation pressure.

According to some embodiments, there is provided a multi-purpose tire comprising: a tread section comprising a main tread zone and at least one auxiliary tread zone, the tread section is configured to facilitate, at a first inflation pressure, a first tread configuration, wherein the at least one auxiliary tread section contacts a road surface and, at a second inflation pressure, a second tread configuration, wherein a contact of the at least one auxiliary tread section with the road is prevented or reduced, the first inflation pressure being lower than the second inflation pressure, wherein the tread section further comprises, in an inner surface thereof, one or more channels extending in a circumferential direction of the tire and configured to regulate an inflation-pressure-dependent transition between the first and second tread configurations. The one or more channels may extend continuously in the circumferential direction of the tire.

According to some embodiments, the one or more channels form a joint structure facilitating the transition between the first and second tread configurations. According to some embodiments, the joint structure may be formed between the one or more channels in the inner surface of the tread section and one or more outer channels formed in an outer surface of the tread section (which is opposing to the inner surface of the tread section). According to some embodiments, the joint structure facilitates a change of an angle between the main tread zone and the at least one auxiliary tread zone which are integrally formed with each other.

According to some embodiments, the one or more channels at least partially contain a substance having elasticity higher than the elasticity of the inner surface, According to some embodiments, the one or more channels at least partially contain a substance having compressibility higher than the compressibility of the inner surface.

According to some embodiments, the main tread zone is a central zone and the at least one auxiliary tread zones comprises two side zones located on both sides of the central zone. According to some embodiments, the tread section includes one main section and one auxiliary section.

According to some embodiments, the first configuration facilitates full load driving mode and the second configuration facilitates light weight driving mode. According to some embodiments, the main tread zone comprises a first outer surface characteristic and the at least one auxiliary comprises a second outer surface characteristic being different from the first outer surface characteristic. According to some embodiments, the main tread section comprises a first outer surface pattern and the at least one auxiliary section comprises a second outer surface pattern being different from the first outer surface pattern. According to some embodiments, the first outer surface pattern is configured to facilitate driving on a paved road and wherein the second outer surface pattern is configured to facilitate driving on “off road” conditions. According to some embodiments, the first outer surface pattern is configured to facilitate driving on an essentially dry road and wherein the second outer surface pattern is configured to facilitate driving on a wet, icy and/or snow covered road. According to some embodiments, the second outer surface comprises studs configured to facilitate driving on an icy and/or snow covered road. According to some embodiments, the second tread configuration facilitates economy driving mode whereas the first tread configuration facilitates high speed driving mode.

According to some embodiments, the tire may further include one or more reinforcing elements extending radially from the tire beads, along the side wall and around the tire, the one or more reinforcing elements are essentially perpendicular to the one or more circumferential channels, wherein the one or more reinforcing elements comprise indentations at locations fitting the one or more circumferential channels. According to some embodiments, the one or more reinforcing elements comprise one or more metal cords.

According to some embodiments, there is provided herein a method of manufacturing a multi-purpose tire, the method comprising: utilizing a tire building machine (TBM), which includes a drum having one or more bulges at preselected location(s), applying one or more layer of tire production material on the drum such that the resulting tire will include a set of circumferential channels in an inner tread section thereof, wherein the locations of the circumferential channels correspond to the locations of the bulges on the drum. According to some embodiments, the tire production material comprises an inner liner, body plies or a combination thereof, wherein the set of circumferential channels are formed at least on the inner liner.

More details and features of the current invention and its embodiments may be found in the description and the attached drawings.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below:

FIG. 1a schematically depicts a cross section of a prior art tire having a correct inflation pressure and a schematic illustration of the tire's contact with the road at the correct inflation pressure;

FIG. 1b schematically depicts a cross section of the tire of FIG. 1a having under-inflation pressure and a schematic illustration of the tire's contact with the road at under-inflation pressure;

FIG. 1c schematically depicts a cross section of the tire of FIG. 1a having over-inflation pressure and a schematic illustration of the tire's contact with the road at over-inflation pressure;

FIG. 2a schematically depicts a cross section of a tire having low inflation pressure (top) and a schematic illustration of the tire's contact with the road at low inflation pressure (bottom), according to an embodiment of the current invention;

FIG. 2b schematically depicts a cross section of the tire of FIG. 2a having medium inflation pressure (top) and a schematic illustration of the tire's contact with the road at medium inflation pressure (bottom), according to an embodiment of the current invention;

FIG. 2c schematically depicts a cross section of the tire of FIG. 2a having high inflation pressure (top) and a schematic illustration of the tire's contact with the road at high inflation pressure (bottom), according to an embodiment of the current invention;

FIG. 3a schematically depicts a cross section of a tire in a first configuration, according to an embodiment of the current invention;

FIG. 3b schematically depicts a cross section of the tire of FIG. 3a in a second configuration, according to an embodiment of the current invention;

FIG. 4a schematically depicts a cross section of a tire configured for “off-road” mode (top) and a schematic illustration of the tire's outer surface pattern and contact with the road (bottom), according to an embodiment of the current invention;

FIG. 4b schematically depicts a cross section of the tire of FIG. 4a configured for “on-road” mode (top) and a schematic illustration of the tire's outer surface pattern and contact with the road (bottom), according to an embodiment of the current invention;

FIG. 4c schematically depicts a cross section of the tire of FIG. 4a configured for “combined” mode (top) and a schematic illustration of the tire's outer surface pattern and contact with the road (bottom), according to an embodiment of the current invention;

FIG. 5a schematically depicts a cross section of a tire configured for “snow” mode (top) and a schematic illustration of the tire's outer surface pattern and contact with the road (bottom), according to an embodiment of the current invention;

FIG. 5b schematically depicts a cross section of the tire of FIG. 5a configured for “dry” mode (top) and a schematic illustration of the tire's outer surface pattern and contact with the road (bottom), according to an embodiment of the current invention;

FIG. 6a schematically depicts a cross section of a tire having grooves filled with a material different from the surrounding material, at a first inflation pressure, according to embodiments of the current invention;

FIG. 6b schematically depicts a cross section of the tire of FIG. 6a, at a second inflation pressure being lower than the first inflation pressure, according to embodiments of the current invention;

FIG. 7a schematically depicts a cross section of a tire having a reinforcing element, according to an embodiment of the current invention;

FIG. 7b schematically depicts the reinforcing element of the tire of FIG. 7a, according to an embodiment of the current invention; and

FIG. 8 schematically depicts a cross section of a tire building machine (TBM), according to an embodiment of the current invention.

### DETAILED DESCRIPTION

While a number of exemplary aspects and embodiments have been discussed above, those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

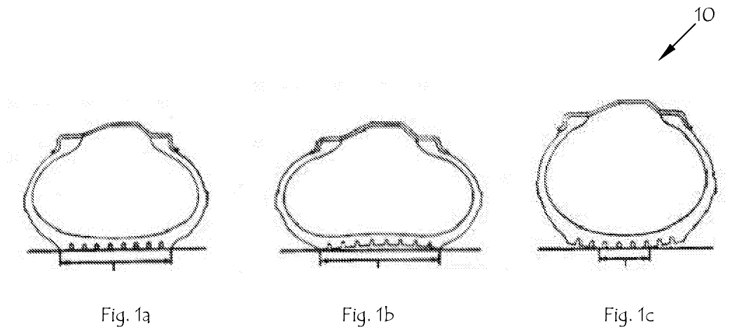

Reference is now made to FIGS. 1a-c, which schematically depict a cross section of a prior art tire (10) designed for a specific optimal inflation pressure. As shown in FIG. 1a, at an optimal inflation pressure the contact of tire 10 with the road is adequate. As shown in FIG. 1b, in under-inflation conditions the tread of tire 10 becomes arched and the contact with the road is decreased. As shown in FIG. 1c, in over-inflation conditions the tread of tire 10 becomes rounded and the contact with the road is also decreased. In such prior art the tires are being manufactured for one given optimal air pressure. In such cases, when air pressure decreases or increases from a pre-designated value, the tire section presents a faulty ground contact and therefore increases tire wear and reduces vehicle performance. As is well known, decreased contact with the road due to undesired or unintended changes in inflation pressure may also jeopardize the driving safety and the well-being of the passengers.

One of the reasons for such tire behavior may relate to the tire mass. The pre-designated pressure is designed to press an even layer of mass outwards. When pressure is reduced to a certain level the, mass creates an un-even contact with the ground since the mass density is constant.

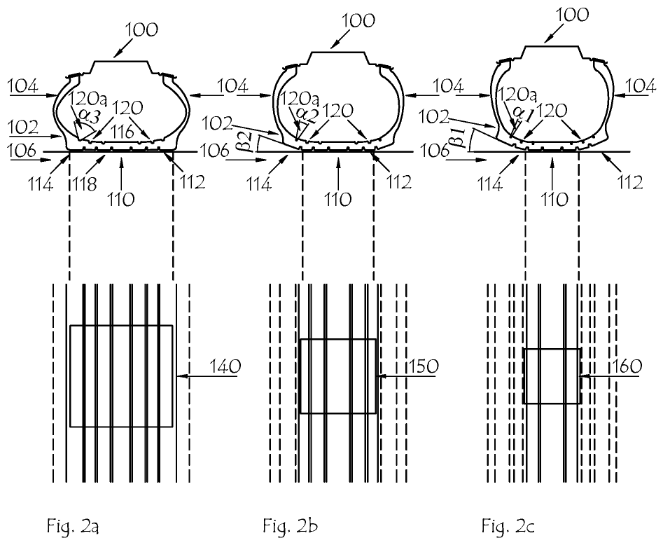

Reference is now made to FIGS. 2a-c, which schematically depict cross sections of a tire 100 having low (FIG. 1a), medium (FIG. 1b) and high (FIG. 1c) inflation pressure values and their respective tire-road contact areas (bottom), according to an exemplary embodiment of the current invention. According to some embodiments, unlike existing tires, tire 100 is designed for more than one pre-determined pressure value. As will be detailed hereinbelow, in any one of the inflation conditions tire 100 demonstrates a controlled and pre-determined tire-road contact areas.

Tire 100 includes a tread section 102 and a side wall 104. Tread section 102 includes an inner surface 116 and an opposing outer surface 118 designed to contact a road surface 106 in a manner dependent on the inflation pressure of tire 100. Tread section 102 may be divided into three sub-sections (zones): a main (central) tread zone 110 and two auxiliary (side) tread zones 112 and 114. Central tread zone 110 and side tread zones 112 and 114 extend continuously in a circumferential direction of tire 100. Central tread zone 110 is located between side tread zone 112 and side tread zone 114.

Inner surface 116 of tire 100 includes channels 120 extending continuously in a circumferential direction of tire 100. Channels 120 are configured to regulate an inflation-pressure-dependent transition between the tread section configurations of tire 100.

In low inflation pressure conditions (FIG. 2a), the entire outer surface 118 contacts road surface 106. In other words, the outer surfaces of all three zones (central tread zone 110 and side tread zones 112 and 114) contact road surface 106 as can be seen from “tread-print” 140.

In medium inflation pressure conditions (FIG. 2b), only a part of outer surface 118 contacts road surface 106. In other words, the outer surface of central tread zone 110 contacts road surface 106 but the outer surfaces of side tread zones 112 and 114 only partially contact road surface 106, as can be seen from “tread-print” 150, which is smaller than “tread-print” 140.

In high inflation pressure conditions (FIG. 2c), a smaller part of outer surface 118 contacts road surface 106. In other words, only the outer surface of central tread zone 110 contacts road surface 106 while the outer surfaces of side tread zones 112 and 114 are lifted and do not contact road surface 106 at all, as can be seen from “tread-print” 160 which is smaller than “tread-print” 150.

According to some embodiments, this multipurpose tire having inflation-pressure-dependent road grip may be accomplished due to channels 120, which allow tread section 102 to re-shape (e.g., bend) in pre-determined locations using the natural elasticity of the mass and the force applied by the air pressure. As tread section 102 responds to different pressure values according to pre-determined modes, tire 100 presents more than one designed road surface grip, allowing various pre-planned modes of contacts with the ground.

By applying internal grooves or flexible belts to the internal tire section opposing the actual tread in pneumatic tire when the tire is under-inflated, it still maintains full tread grip with the ground in given ranges of pressure.

For example, as mentioned above, in low inflation pressure conditions (FIG. 2a), the entire outer surface 118 of tread section 102 is flattened and makes contact with road surface 106. In such configuration, channel 120a, by way of example, has a wide separation angle (alpha) α1, which facilitates the desired flattening and road contact of tread section 102.

In medium inflation pressure conditions (FIG. 2b), the outer surface of central tread zone 110 makes contact with road surface 106, but the outer surfaces of side tread zones 112 and 114 only partially make contact with road surface 106. In such configuration, and again, by way of example, channel 120a has a separation angle narrower than (alpha) α1, now represented by (alpha) α2. The desired bending of tread section 102 allowing the lifting of side tread zone 114 from road surface 106 is facilitated by the narrowing of the separation angle of channel 120a from (alpha) α1 to (alpha) α2. Of course, the same applies for the lifting of side tread zone 114 from road surface 106 (angles not marked).

In high inflation pressure conditions (FIG. 2c), only the outer surface of central tread zone 110 makes contact with road surface 106 while the outer surfaces of side tread zones 112 and 114 are lifted and do not make contact with road surface 106 at all. In such configuration, again, by way of example, channel 120a has an even smaller separation angle narrower than (alpha) α2, now represented by (alpha) α3. The desired bending of tread section 102 allowing the lifting of side tread zone 114 from road surface 106 is facilitated by the narrowing of the separation angle of channel 120a from (alpha) α2 to (alpha) α3. Of course, the same applies for the lifting of side tread zone 114 from road surface 106 (angles not marked). According to some embodiments, tire 100 is configured for both “full performance” and “saving” modes, respectively. When tire 100 is inflated with a low inflation pressure (FIG. 2a), the entire outer surface of its tread section (formed from the outer surfaces of central tread zone 110 and side tread zones 112 and 114) make contact with road surface 106. When tire 100 is inflated with a high inflation pressure (FIG. 2c), only the outer surfaces of central tread zone 110 make contact with road surface 106. FIG. 2c represents a driving mode between “full performance” and “saving” modes. As schematically depicted in the bottom sections of FIGS. 2a-c, although the outer surface of central tread zone 110 are similar to the outer surfaces of side tread zones 112 and 114, when only the outer surface of central tread zone 110 makes contact with the ground, tire 100 is adapted for “saving” mode, and when the outer surfaces of side tread zones 112 and 114 are also in contact with the ground, the same tire 100 is adapted for better grip of the ground and accordingly for “full performance” driving mode. The transition from “full performance” to “saving” modes and vice versa is inflation-pressure dependent and can be accomplished by structures 120, which can be the same or different and can be, as non-limiting examples, grooves, empty grooves or groove filled (or partially filled) with material(s) having different properties than the material forming the groove.

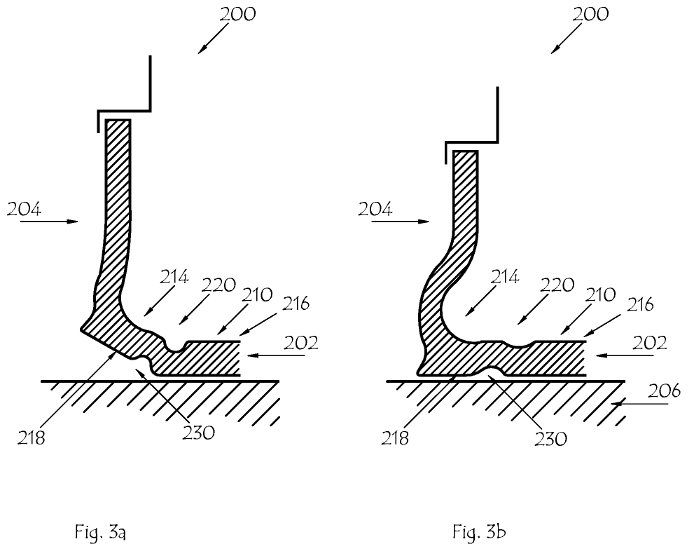

Reference is now made to FIGS. 3a-b, which schematically depict cross sections of a tire (part) in a first (high inflation pressure) and a second (low inflation pressure) configuration, respectively, according to an embodiment of the current invention. According to some embodiments, tire 200 (only partially shown) is designed for more than one pre-determined pressure value. Tire 200 includes a tread section 202 and a side wall 204. Tread section 202 includes an inner surface 216 and an opposing outer surface 218 designed to contact the road surface 206 in a manner dependent on the inflation pressure of tire 200. Tread section 202 may be divided into three sub-sections (zones): a main (central) tread zone 210 and two auxiliary (side) tread zones. Only one side tread zone 214 is shown in this figure. Central tread zone 210 and side tread zone 214 extend continuously in a circumferential direction of tire 200. Central tread zone 210 is located between the two side tread zones.

Inner surface 216 of tire 200 includes channel 220 extending continuously in a circumferential direction of tire 200. Outer surface 218 of tire 200 also includes a channel 230 (for example, extending continuously in a circumferential direction of tire 200). It is noted that more channels, such as channels 220 and 230, may be present but not shown herein for the purpose of simplicity. Channels 220 and 230 are (slightly) shifted with respect to one another creating a “joint” structure facilitating a bending between central tread zone 210 and side tread zone 214 allowing side zone 214 to lift from road surface 206 when inflation pressure increases (FIG. 3a). This structure provides a multipurpose tire adapted to more than one vehicle operation/driving mode and/or road condition.

It is noted that although only two or three tread configurations are presented herein, embodiments of this invention are also directed to a larger number of tread configurations such as about 2-7, 3-10, 5-15, more than about 10, etc. According to some embodiments, the tread structure and/or composition may be configured to facilitate a pressure driven transition between multiple tread configurations. The transition may be continuous.

Road (ground) contact of the outer surfaces of the two side zones can be regulated (e.g., increased or reduced) by different pressure applied to the tire. The operator can thus use the vehicle for different functions using the same set of tires.

According to some embodiments, the outer surface of the side zones may be designed for use on dirt roads while the central zone may be designed for paved road allowing the vehicle to perform all-road service using the same set of tires. When higher pressure is applied, the side zones are lifted from the ground (as, for example, in FIG. 2c) and the vehicle is in paved road driving mode. When air pressure is reduced, the side zones designed for better ground grip are in contact with the ground (as, for example, in FIG. 2a) and the vehicle is in off-road driving mode.

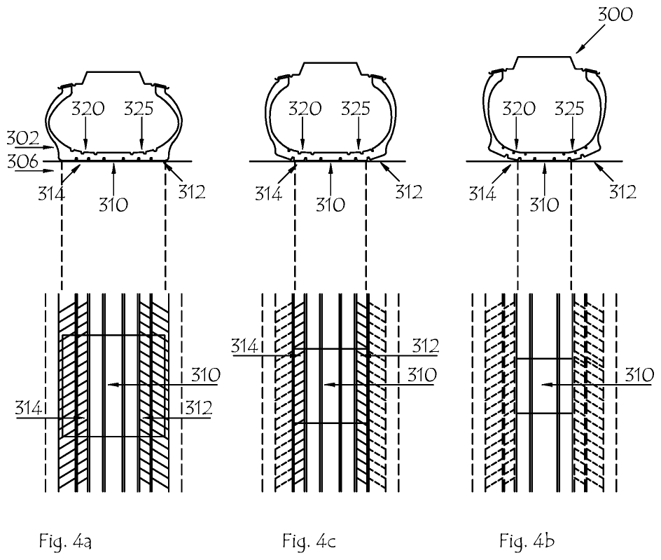

Reference is now made to FIGS. 4a-c, which schematically depicts a cross section of a tire 300 configured for “off-road”, “on-road” and “combined” modes, respectively. Tread section 302 of tire 300 has two types of outer surfaces for contacting road 306: central tread zone 310 has an outer surface pattern configured for “on-road” driving and side tread zones 312 and 314 having an outer surface pattern configured for “off-road” driving. Of course, more than two outer surface pattern are possible, for example, 2-5, 3-7 etc. When tire 300 is inflated with a low inflation pressure (FIG. 4a), the entire outer surface of its tread section (formed from the outer surfaces of central tread zone 310 and side tread zones 312 and 314) makes contact with road surface 306. When tire 300 is inflated with a high inflation pressure (FIG. 4b), only the outer surfaces of central tread zone 310 make contact with road surface 306. As schematically depicted in the bottom sections of FIGS. 4a-c, the outer surface of central tread zone 310 is adapted for “on-road” driving mode, while the outer surfaces of side tread zones 312 and 314 are adapted for “off-road”. Therefore, when only the outer surface of central tread zone 310 makes contact with the ground, tire 300 is adapted for “on-road” driving mode, and when the outer surfaces of side tread zones 312 and 314 are also in contact with the ground, the same tire 300 is adapted for “off-road”. When (as shown in FIG. 4c) the outer surface of central tread zone 310 makes contact with the ground, tire 300 and the outer surfaces of side tread zones 312 and 314 are partially in contact with the ground, the same tire 300 is adapted for “combined” mode, which may be used in a semi-paved road for example.

The transition from “on-road” to “combined” and to “off-road” and vice versa is inflation-pressure dependent and can be accomplished by structures 320 and 325, which can be the same or different and can be, as non-limiting examples, grooves.

According to some embodiments, the outer surface of the side zones may be equipped with metal studs designated for snow conditions while the central zone is designed for dry road conditions. When higher pressure is applied, the side zones are lifted from the ground and the vehicle is in dry road driving mode. When air pressure is reduced, the side zones with snow studs are in contact with the ground and the vehicle is in snow driving mode.

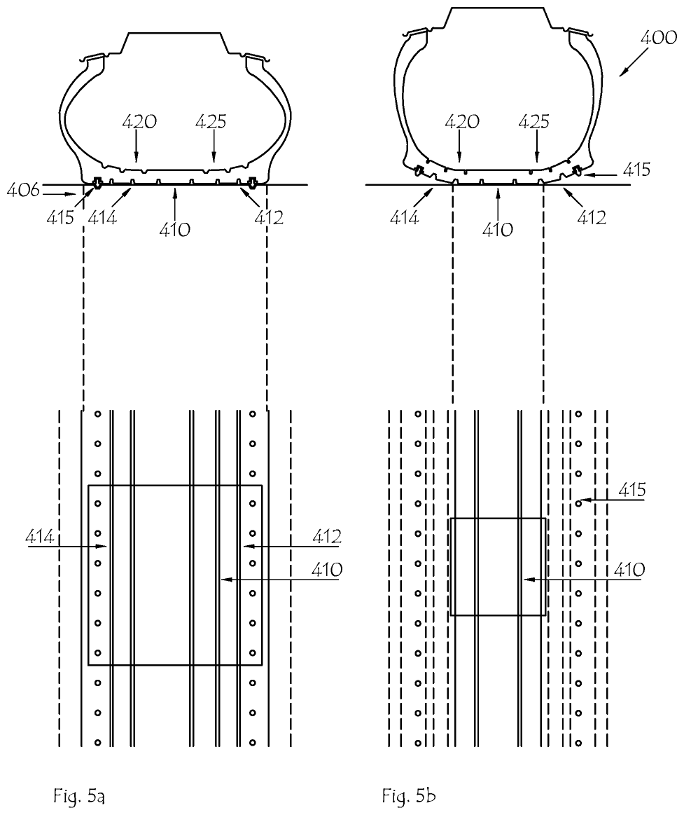

Reference is now made to FIGS. 5a-b, which schematically depicts a cross section of a tire 400 configured for both “snow” and “dry” modes, respectively. When tire 400 is inflated with a low inflation pressure (FIG. 5a), the entire outer surface of its tread section (formed from the outer surfaces of central tread zone 410 and side tread zones 412 and 414) makes contact with road surface 406. When tire 400 is inflated with a high inflation pressure (FIG. 5a), only the outer surfaces of central tread zone 410 make contact with road surface 406. As schematically depicted in the bottom sections of FIGS. 5a-b, the outer surface of central tread zone 410 is adapted for “dry” driving mode, while the outer surfaces of side tread zones 412 and 414 are adapted for “snow” driving mode. The outer surfaces of side tread zones 412 and 414 may also include studs (spikes or barbs) 415 to facilitate grip on snowy roads. Therefore, when only the outer surface of central tread zone 410 makes contact with the ground, tire 400 is adapted for “dry” driving mode, and when the outer surfaces of side tread zones 412 and 414 are also in contact with the ground, the same tire 400 is adapted for driving in the snow. The transition from “snow” to “dry” and vice versa is inflation-pressure dependent and can be accomplished by structures 420 and 425, which may be, as non-limiting examples, grooves. According to some embodiments, structures 420 may be the same as structures 425. According to some embodiments, structures 420 may be different from structures 425.

According to some embodiments, the outer surface of the side zones may be designed for high speed driving while the central zone may be designed for standard economy driving. When higher pressure is applied, the side zones are lifted from the ground and the vehicle is in economy driving mode, fit for slow speed in city roads, for example. When air pressure is reduced, the side zones are in contact with the ground and the vehicle is in high speed driving mode. According to some embodiments, the outer surface of the side zones may be equipped with metal studs designated for snow conditions while the central zone is designed for dry road conditions. When higher pressure is applied, the side zones are lifted from the ground and the vehicle is in dry road driving mode. When air pressure is reduced, the side zones with snow studs are in contact with the ground and the vehicle is in snow driving mode.

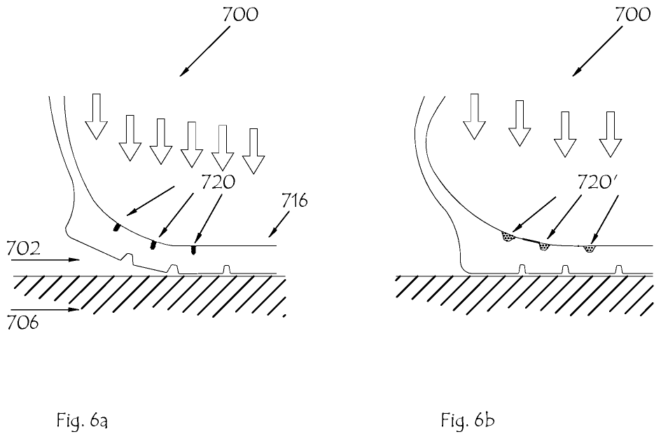

Reference is now made to FIGS. 6a-b, which schematically depict a cross section of a tire 700 having grooves 720/720′ in an inner surface 716 of a tread section 702 thereof. Grooves 720 are filled with a material different (e.g., more elastic or more compressible) than the surrounding material of inner surface 716. This material allows narrowing/widening of the grooves depending on the inflation pressure in tire 700. By way of example, FIG. 6a depicts grooves 720 at a first inflation pressure, while FIG. 6b depicts grooves 720′ at a second inflation pressure being lower than the first inflation pressure (as depicted by the hollow arrows), according to embodiments of the current invention. When inflation pressure increases, (shifting from the low pressure depicted in FIG. 6b to the higher pressure depicted in FIG. 6a) the filing material of the grooves is flexible (or compressible) enough that it allows the grooves to narrow (from configuration 720′ to 720), and vice versa. As a result, tread section 102 is lifted from road surface 706 in a desired manner dependent on the inflation pressure of tire 700.

In heavy vehicles, such as trucks, for example, the side zones may be designed for increased loads while the central zone is designed for an unloaded drive. When higher pressure is applied, the side zones are lifted from the ground and the truck is in light weight driving mode. When air pressure is reduced, the side zones are in contact with the ground and the truck is in full load driving mode. In addition, in heavy vehicles, such as trucks, steel cords are typically incorporated into the tire as reinforcing elements. These cords run radially (from the tire beads) down the side wall and all the way around the tire. A track typically has about 1200 cords in a tire. The steel cords and the tire rubber allow a combination of strength and flexibility and thus help absorb shock from uneven road surfaces. When used in tires, according to some embodiments of the current invention, the radial (steel) cords may be made to assume the indentations which may be compatible to the tire circumferential grooves.

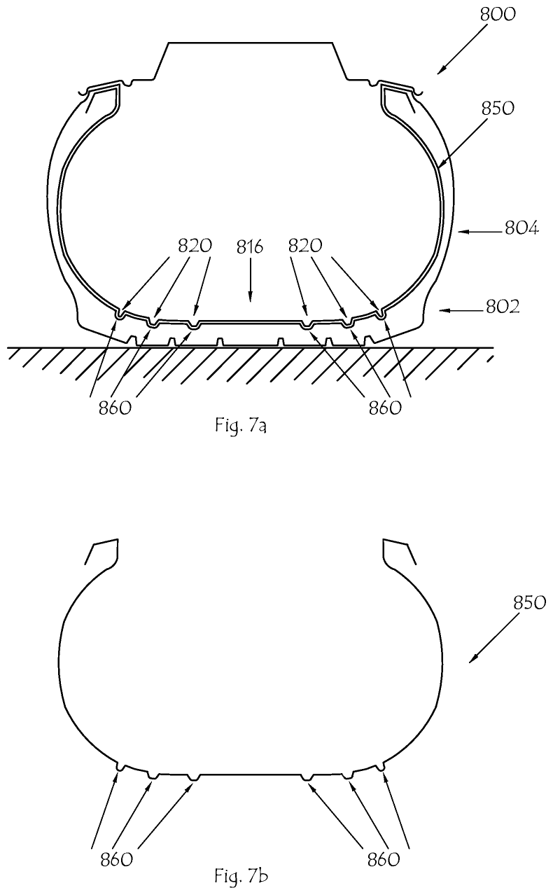

Reference is now made to FIG. 7a, which schematically depicts a cross section of a tire 800 having a reinforcing element 850, according to an embodiment of the current invention. FIG. 7b schematically depicts reinforcing element 850 of tire 800 of FIG. 7a, according to an embodiment of the current invention. Reinforcing element 850 is a cord (typically a metal, such as steel cord, configured to run radially down side wall 804 and all the way around tire 800. Reinforcing element 850 includes indentations 860 (may also be referred to as bent or curved sections), which are configured to fit circumferential grooves 820 located in an inner surface 816 of a tread section 802 of tire 800. Reinforcing element 850 is essentially perpendicular to grooves (channels) 820.

A tire building process typically includes assembling all the tire components onto a tire building drum. Tire-building machines (TBM) can be manually operated or partially/fully automatic. Typical TBM operations include the first-stage operation, where inner liner, body plies, and sidewalls are wrapped around the drum, the beads are placed, and the assembly turned up over the bead. In the second stage operation, the carcass of the tire is inflated, then the belt package and tread are applied. According to some embodiments of the invention, the tire building drum (e.g. a rotating drum) includes one or more bulges at preselected location(s). Therefore applying one or more layer of tire production material (for example an inner liner on the drum will result in a tire having a set of circumferential channels in an inner tread section thereof, at location(s) corresponding to the location(s) of the bulges on the drum).

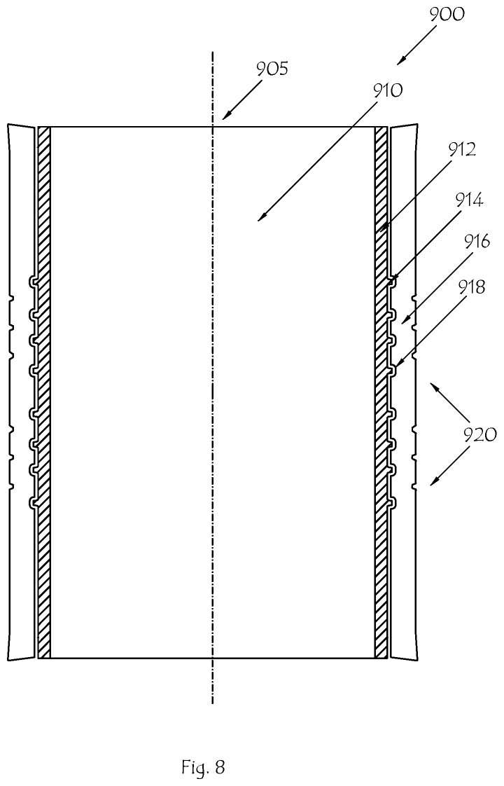

Reference is now made to FIG. 8, which schematically depicts a cross section of a tire building machine (TBM) 900, according to an embodiment of the current invention. TBN 900 includes a drum 910. During tire manufacturing, drum 910 may revolve around a longitudinal axis 905 thereof. An outer surface 912 of drum 910 includes a set of bulges, such as bulge 914. During tire manufacturing, the tire plies 916 are laid on outer surface 912 of drum 910 such that grooves (channels/recesses) such as groove 918 are formed in at least one of the tire plies 916 around the bulges (such as bulge 914). As the manufacturing process advances, a tire section (920) that includes the grooves becomes a tread section of the tire, having grooves at an inner section thereof.

According to some embodiments, the term “high inflation pressure” may include an inflation pressure of about 30-40 psi (for example, 33-35 psi, 34-36 psi, 32-37 psi, etc.). According of some embodiments, the term “medium inflation pressure” may include an inflation pressure of about 20-30 psi (for example, 20-25 psi, 22-27 psi, 25-28-37 psi, etc.). According of some embodiments, the term “low inflation pressure” may include an inflation pressure of about 12-20 (for example, 13-15, 14-16 psi, 15-17 psi, 15-19 psi, etc.).

According to some embodiments, the “tread section” includes two opposing surfaces: an outer surface, designed to make contact with the road, an inner surface opposing to the outer surface and any layer that may be disposed between the two surfaces. According of some embodiments, the term “inner surface” of the tread section may include an inner liner, an under-tread layer, a cap plie, a belt (e.g., rubber, steel, nylon or any other belt), carcass or any other layer or combination of layers.

According to some embodiments, the “tread section” does not include the tire's side walls.

According to some embodiments, the terms “channel(s)” and “groove(s)” may be used interchangeably.

In the description and claims of the application, each of the words “comprise” “include” and “have”, and forms thereof, are not necessarily limited to members in a list with which the words may be associated.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What we claim is:

1. A multi-purpose tire comprising:
a tread section comprising a main tread zone and at east one auxiliary tread zone,
the tread section is configured to facilitate, at a first inflation pressure, a first tread configuration, wherein the at least one auxiliary tread section makes contact with a road surface and, at a second inflation pressure, a second tread configuration, wherein a contact of the at least one auxiliary tread section with the road is prevented or reduced, the first inflation pressure being lower than the second inflation pressure, wherein the tread section further comprises, in an inner surface thereof, one or more channels extending continuously in a circumferential direction of the tire and configured to regulate an inflation-pressure-dependent transition between the first and second tread configurations.

2. The tire of claim 1, wherein the one or more channels form a joint structure facilitating the transition between the first and second tread configurations.

3. The tire of claim 1, wherein the one or more channels at least partially contain a substance having elasticity higher than the elasticity of the inner surface.

4. The tire of claim 1, wherein the one or more channels at least partially contain a substance having compressibility higher than the compressibility of the inner surface.

5. The tire of claim 1, wherein the main tread zone is a central zone and the at least one auxiliary tread zones comprise two side zones located on both sides of the central zone.

6. The tire of claim 1, wherein the first configuration facilitates fell load driving mode and wherein the second configuration facilitates light weight driving mode.

7. The tire of claim 1, wherein the main tread zone comprises a first outer surface characteristic and the at least one auxiliary comprises a second outer surface characteristic being different from the first outer surface characteristic.

8. The tire of claim 7, wherein the main tread section comprises a first outer surface pattern and the at least one auxiliary section comprises a second outer surface pattern being different from the first outer surface pattern.

9. The tire of claim 8, wherein the first outer surface pattern is configured to facilitate driving on a paved road and wherein the second outer surface pattern is configured to facilitate driving on “off road” conditions.

10. The tire of claim 8, wherein the first outer surface pattern is configured to facilitate driving on an essentially dry road and wherein the second outer surface pattern is configured to facilitate driving on a wet, icy and/or snow covered road.

11. The tire of claim 7, wherein the second outer surface comprises studs configured to facilitate driving on an icy and/or snow covered road.

12. The tire of claim 1, wherein the second tread configuration facilitates economy driving mode and wherein the first tread configuration facilitates high speed driving mode.

13. The tire of claim 1, further comprises one or more reinforcing elements extending radially from the tire beads, along the side wall and around the tire, the one or more reinforcing elements are essentially perpendicular to the one or more circumferential channels, wherein the one or more reinforcing elements comprise indentations at locations fitting the one or more circumferential channels.

14. The tire of claim 13, wherein the one or more reinforcing elements comprise one or n ore metal cords.

15. A method of manufacturing a multi-purpose tire, the method comprising: utilizing a tire building machine (TBM) comprising a drum having one or more bulges at preselected location(s), applying one or more layer of tire production material on the drum such that the resulting tire will include a set of circumferential channels in an inner tread section thereof, wherein the locations of the circumferential channels correspond to the locations of the bulges on the drum.

16. The method of claim 13, wherein the tire production material comprises an inner liner, body plies or a combination thereof, wherein the set of circumferential channels are formed at least on the inner liner.
